(19) United States
(12) Patent Application Publication
(10) Pub. No.: US 2012/0283851 A1
(43) Pub. Date: Nov. 8, 2012

(54) CONTROL PARAMETER ADJUSTMENT METHOD AND ADJUSTMENT DEVICE

(75) Inventor: Hideaki Yamamoto, Minato-ku (JP)

(73) Assignee: MITSUBISHI HEAVY INDUSTRIES, LTD., Tokyo (JP)

(21) Appl. No.: 13/512,843

(22) PCT Filed: Sep. 15, 2010
(86) PCT No.: PCT/JP2010/065910

§ 371 Date: Jul. 25, 2012

(30) Foreign Application Priority Data
Dec. 25, 2009 (JP) 2009-294028

(51) Int. Cl. G05B 19/18

(52) U.S. Cl. 700/56

(57) ABSTRACT

A control parameter adjustment method and adjustment device automatically adjusts control parameters to appropriate values in response to aging-change of a movement mechanism. Included are a first processing step for notification of an adjustment-use NC program to a numeric control device and registration thereof; second processing step wherein the numeric control device executes the adjustment-use NC program and outputs an adjustment-use position instruction; third processing steps for obtaining a maximum error margin, and fourth processing steps for assessing whether or not the maximum error margin is less than or equal to a tolerance. If the maximum error margin is greater than the tolerance, the acceleration/deceleration time-constant is modified to a large value, and is output after modification to the numeric control device. In the fourth processing, until it is determined that the maximum error margin is less than or equal to the tolerance, the second to fourth processing steps are repeated.

### TECHNICAL FIELD

The present invention relates to a method and a device for adjusting a control parameter used in numerical control on movement of a movable body through a moving mechanism such as a feeding mechanism of a machine tool.

### BACKGROUND ART

As position control through a servomotor used in a machine tool, feedback control, which is a classical control theory, is generally used. FIG. 12 shows the configuration of a servo control device configured to perform feedback control.

As shown in FIG. 12, a numerical control target 1 in a machine tool is formed of a servo control device 2 as a control system, a feeding mechanism 3 as a mechanical system, and the like. Though a detailed description is omitted here, the feeding mechanism 3 is formed of a servomotor 4, reduction gears 5, support bearings 6, brackets 7, a ball screw 8 (screw portion 8a, nut portion 8b), and the like, and is configured to move a movable body 9 (load inertia), such as a table or a column, straight as shown by an arrow A.

The servo control device 2 is configured to control the rotation of the servomotor 4 on the basis of a position command from a numerical control device, position feedback from a position detector 10 detecting the position of the movable body 9, and speed feedback from a rotational speed detector 11 detecting the rotational speed of the servomotor 4, so that the moving position of the movable body 9 would be controlled to follow the position command. Parameters used in this servo control device 2 include (a) position loop gain (Kp), (b) speed loop gains (proportional gain Kv, integral gain Kvi), and the like, and these parameters in the servo control system are important factors in the position control.

Meanwhile, with the feedback control by the servo control device 2 in FIG. 12, the actual position of the movable body 9 follows the position command with a lag. However, the servo control system may have a function to compensate for this lag, such as (c) feedforward control function or (d) quadrant glitch compensation function. For example, a servo control device 2 shown in FIG. 13 is the same servo control system as that in FIG. 12 but has a feedforward control unit 13 added thereto. A servo control device 2 shown in FIG. 14 is the same servo control system as that in FIG. 12 but has a quadrant glitch compensation unit 16 added thereto.

Meanwhile, a high-speed machining function refers to a general function for suppressing deformation of an object in high-speed machining of a machine tool. To implement this high-speed machining function, the numerical control device is generally equipped with (e) smoothing processing function, (f) corner deceleration processing function, (g) pre-interpolation acceleration/deceleration processing function, (h) post-interpolation acceleration/deceleration processing function, and the like as its functions, in addition to the servo control system's functions such as (c) feedforward control function and (d) quadrant glitch compensation function. A conventional numerical control device 17 illustrated in FIG. 15 includes an NC program analysis processing unit 18, a smoothing processing unit 19, a corner deceleration processing unit 20, a pre-interpolation acceleration/deceleration processing unit 21, a processing unit 22 for assigning commands to the axes (interpolation processing unit), and a post-interpolation acceleration/deceleration processing unit 23.

Control parameters related to the above-described functions (a) to (d) and (f) to (h) need to be adjusted in accordance with the control target. In conventional practices, these control parameters are adjusted based on measurement results obtained by using measurement devices and also based on the operator's experience and intuition. That is, the operator him/herself finds an appropriate set value for each of the control parameters on the basis of the measurement results and sets manually the control parameters to the devices (numerical control device 17, servo control device 2).

The inventions of Patent Documents 1 to 5 listed below are proposed to solve this problem, i.e., to implement automatic adjustment of the parameters in the servo control system ((a) position loop gain, (b) speed loop gains, (c) feedforward control function, and (d) quadrant glitch compensation function). Moreover, the invention of Patent Document 6 listed below is proposed to implement automatic adjustment of the parameters related to the numerical control side of the high-speed machining function ((c) feedforward control function, (f) corner deceleration processing function, and (g) post-interpolation acceleration/deceleration processing function).

### PRIOR ART DOCUMENTS

### Patent Documents

Patent Document 1: Japanese Patent Application Publication No. Hei 2-261083

Patent Document 2: Japanese Patent Application Publication No. Hei 3-84603

Patent Document 3: Japanese Patent Application Publication No. Hei 8-221132

Patent Document 4: Japanese Patent No. 4327880

Patent Document 5: Japanese Patent Application Publication No. Hei 11-102211

Patent Document 6: Japanese Patent Application Publication No. 2004-188541

Patent Document 7: Japanese Patent Application Publication No. Hei 4-30945

### SUMMARY OF THE INVENTION

### Problem to be Solved by the Invention

Meanwhile, the mechanical system of the numerical control target 1 in the machine tool is formed of the reduction gears 5, the support bearings 6, the brackets 7, the ball screw 8, and the like, which are the components of the feeding mechanism 3, as well as the movable body 9, as shown in FIG. 12, and the control characteristics of the reduction gears 5, the support bearings 6, and the ball screw 8 of the feeding mechanism 3 change over time due to wear of these components. The numerical value of lost motion, which is an index indicating the characteristics of the feeding mechanism 3, and the like change and increase over time in general. The invention of Patent Document 7 listed above is proposed to detect this change in lost motion of the feeding mechanism over time.

Changes in the control characteristics of the components of the feeding mechanism 3 over time change the appropriate values of the parameters related to the above-described functions (a) to (d) and (f) to (h), thereby leading to a situation where the machining accuracy of the machine tool is deteriorated. Ina case of facing such a situation, mechanical adjustment of the feeding mechanism 3 and the like are performed in a conventional practice in attempt to regain the original control characteristics given when the feeding mechanism 3 was brand new. However, the reality is that it is impossible to regain the control characteristics of the components having been changed over time due to wear thereof to the brand new levels without replacing the components. Consequently, there arises a problem that the parameters related to the above-described functions (a) to (d) and (f) to (h) cannot always be set to appropriate values due to the changes over time.

Thus, in view of the above circumstances, the present invention has an object to provide a control parameter adjustment method and adjustment device capable of automatically adjusting control parameters to appropriate values when the control characteristics of components of a moving mechanism (such as a feeding mechanism of a machine tool) subjected to numerical control change over time.

### Means for Solving the Problem

A control parameter adjustment method, according to a first invention for solving the above problem, is used in a control system in which a servo control device performs feedback control on a moving mechanism in such a way that a position of a movable body moved by the moving mechanism follows a position command outputted from a numerical control device, the control parameter adjustment method being used for adjusting an acceleration/deceleration time constant being a control parameter related to a pre-interpolation acceleration/deceleration processing function of the numerical control device, the control parameter adjustment method characterized in that

the control parameter adjustment method comprises performing:

first processing to notify the numerical control device of an adjustment NC program and register the adjustment NC program in the numerical control device;

second processing to cause the numerical control device to execute the adjustment NC program to output an adjustment position command;

third processing to find a largest error being a largest value in a difference between the adjustment position command and the position of the movable body fed back from a position detector of the movable body, the position of the movable body being fed back when the servo control device performs feedback control on the moving mechanism in such a way that the position of the movable body follows the adjustment position command; and

fourth processing to judge whether or not the largest error is equal to or smaller than an allowable error, change the acceleration/deceleration time constant to a larger value if the largest error is judged as greater than the allowable error, and output the changed acceleration/deceleration time constant to the numerical control device, and

the second processing, the third processing, and the fourth processing are iterated until the largest error is judged as equal to or smaller than the allowable error in the fourth processing.

A control parameter adjustment method, according to a second invention, is used in a control system in which a servo control device performs feedback control on a moving mechanism in such a way that a position of a movable body moved by the moving mechanism follows a position command outputted from a numerical control device, the control parameter adjustment method being used for adjusting a corner clamp acceleration being a control parameter related to a corner deceleration processing function of the numerical control device, the control parameter adjustment method characterized in that

the control parameter adjustment method comprises the steps of:

performing first processing to notify the numerical control device of an adjustment NC program and register the adjustment NC program in the numerical control device;

performing second processing to cause the numerical control device to execute the adjustment NC program to output an adjustment position command;

performing third processing to find a largest error being a largest value in a difference between the adjustment position command and the position of the movable body fed back from a position detector of the movable body, the position of the movable body being fed back when the servo control device performs feedback control on the moving mechanism in such a way that the position of the movable body follows the adjustment position command;

performing fourth processing to judge whether or not the largest error is equal to or smaller than an allowable error, change the corner clamp acceleration to a smaller value if the largest error is judged as greater than the allowable error, and output the changed corner clamp acceleration to the numerical control device; and

iterating the second processing, the third processing, and the fourth processing until the largest error is judged as equal to or smaller than the allowable error in the fourth processing.

The control parameter adjustment method according to a third invention, in the control parameter adjustment method according to the first invention, is characterized in that the acceleration/deceleration time constant changed to the larger value in the fourth processing and a set allowable value are compared with each other, and if the changed acceleration/deceleration time constant is judged as equal to or greater than the set allowable value, information indicating abnormal degradation of the moving mechanism is outputted to abnormality alarming means.

The control parameter adjustment method according to a fourth invention, in the control parameter adjustment method according to the second invention, is characterized in that in the fourth processing, the corner clamp acceleration changed to the smaller value and a set allowable value are compared with each other, and if the changed corner clamp acceleration is judged as equal to or smaller than the set allowable value, information indicating abnormal degradation of the moving mechanism is outputted to abnormality alarming means.

A control parameter adjustment device, according to a fifth invention, is used in a control system in which a servo control device performs feedback control on a moving mechanism in such a way that a position of a movable body moved by the moving mechanism follows a position command outputted from a numerical control device, the control parameter adjustment device being used for adjusting an acceleration/deceleration time constant being a control parameter related to a pre-interpolation acceleration/deceleration processing function of the numerical control device, the control parameter adjustment device characterized in that

the control parameter adjustment device comprises:

an adjustment NC program storage unit configured to store an adjustment NC program;

an NC program notification processing unit configured to read the adjustment NC program from the adjustment NC program storage unit and notify the numerical control device of the adjustment NC program;

an accuracy analysis processing unit configured to find a largest error being a largest value in a difference between an adjustment position command and the position of the movable body and judge whether or not the largest error is equal to or smaller than an allowable error, the adjustment position command being outputted from the numerical control device by executing the adjustment NC program, the position of the movable body being fed back from a position detector of the movable body when the servo control device performs feedback control on the moving mechanism in such a way that the position of the movable body follows the adjustment position command;

a parameter adjustment processing unit configured to change the acceleration/deceleration time constant to a larger value if the accuracy analysis processing unit judges that the largest error is greater than the allowable error; and

a parameter setting output processing unit configured to output the acceleration/deceleration time constant changed by the parameter adjustment processing unit to the numerical control device.

A control parameter adjustment device, according to a sixth invention, is used in a control system in which a servo control device performs feedback control on a moving mechanism in such a way that a position of a movable body moved by the moving mechanism follows a position command outputted from a numerical control device, the control parameter adjustment device being used for adjusting a corner clamp acceleration being a control parameter related to a corner deceleration processing function of the numerical control device, the control parameter adjustment device characterized in that

the control parameter adjustment device comprises:

an adjustment NC program storage unit configured to store an adjustment NC program;

an NC program notification processing unit configured to read the adjustment NC program from the adjustment NC program storage unit and notify the numerical control device of the adjustment NC program;

an accuracy analysis processing unit configured to find a largest error being a largest value in a difference between an adjustment position command and the position of the movable body and judge whether or not the largest error is equal to or smaller than an allowable error, the adjustment position command being outputted from the numerical control device by executing the adjustment NC program, the position of the movable body being fed back from a position detector of the movable body when the servo control device performs feedback control on the moving mechanism in such a way that the position of the movable body follows the adjustment position command;

a parameter adjustment processing unit configured to change the corner clamp acceleration to a smaller value if the accuracy analysis processing unit judges that the largest error is greater than the allowable error; and

a parameter setting output processing unit configured to output the corner clamp acceleration changed by the parameter adjustment processing unit to the numerical control device.

The control parameter adjustment device according to a seventh invention, in the control parameter adjustment device according to the fifth invention, is characterized in that the parameter setting output processing unit compares the acceleration/deceleration time constant changed to the larger value by the parameter adjustment processing unit and a set allowable value, and if judging the changed acceleration/deceleration time constant as equal to or greater than the set allowable value, outputs information indicating abnormal degradation of the moving mechanism to abnormality alarming means.

The control parameter adjustment device according to an eighth invention, in the control parameter adjustment device according to the sixth invention, is characterized in that the parameter setting output processing unit compares the corner clamp acceleration changed to the smaller value by the parameter adjustment processing unit and a set allowable value, and if judging the changed corner clamp acceleration as equal to or smaller than the set allowable value, outputs information indicating abnormal degradation of the moving mechanism to abnormality alarming means.

### Effects of the Invention

With the control parameter adjustment method of the first or second invention, and the control parameter adjustment device of the fifth or sixth invention, effects (1) to (4) described below can be achieved. Moreover, with the control parameter adjustment method of the third or fourth invention, and the control parameter adjustment device of the seventh or eighth invention, an effect (5) described below can be achieved.

(1) Change in the position accuracy of a moving mechanism (e.g., machining accuracy in a case of a machine tool) over time can be figured out.

(2) A desired position accuracy can be achieved automatically even in a case of a moving mechanism experiencing aging.

(3) The position accuracy can be maintained as high as the brand new level without performing a repair work (maintenance) and the like of the moving mechanism for a long period of time.

(4) The maintenance service cost can be reduced since the position accuracy of the moving mechanism can be maintained at a high level for a long period of time without maintenance.

(5) The degree of aging (the degree of degradation) of the moving mechanism can be automatically detected since the position accuracy of the moving mechanism is automatically figured out.

### BRIEF DESCRIPTION OF THE DRAWINGS

FIG. 1 is a block diagram showing the configuration of an overall control system related to numerical control on a machine tool including a device for automatically adjusting a high-speed machining function and the like designed to implement a control parameter adjustment method of an embodiment of the present invention.

FIG. 2 is a diagram for describing overviews of a corner deceleration processing function and a pre-interpolation acceleration/deceleration processing function of a numerical control device.

FIG. 3 is a diagram for describing overviews of a corner deceleration processing function and a pre-interpolation acceleration/deceleration processing function of a numerical control device.

FIG. 4 is a diagram corresponding to FIG. 1 and is a block diagram showing a specific example of the configuration of a servo control device.

FIG. 5 is a diagram corresponding to FIG. 1 and is a block diagram showing another specific example of the configuration of a servo control device.

FIG. 6 is a flowchart showing a procedure to adjust a control parameter (acceleration/deceleration time constant) related to the pre-interpolation acceleration/deceleration processing function of the numerical control device.

FIG. 7 is an explanatory diagram of the profile of an adjustment command related to the pre-interpolation acceleration/deceleration processing function of the numerical control device.

FIG. 8 is an explanatory diagram showing an example of judgment on a machining error (machining accuracy) related to the pre-interpolation acceleration/deceleration processing function of the numerical control device.

FIG. 9 is a flowchart showing a procedure to adjust a control parameter (corner clamp acceleration) related to the corner deceleration processing function of the numerical control device.

FIG. 10 is an explanatory diagram of the profile of an adjustment command related to the corner deceleration processing function of the numerical control device.

FIG. 11 is an explanatory diagram showing an example of judgment on a machining error (machining accuracy) related to the corner deceleration processing function of the numerical control device.

FIG. 12 is a block diagram showing an example of the configuration of a conventional servo control device.

FIG. 13 is a block diagram showing an example of the configuration of a conventional servo control device equipped with a feedforward control function.

FIG. 14 is a block diagram showing an example of the configuration of a conventional servo control device equipped with a quadrant glitch compensation function.

FIG. 15 is a block diagram showing the flow of processing in a conventional high-speed machining function.

### MODE FOR CARRYING OUT THE INVENTION

Hereinbelow, an embodiment of the present invention will be described in detail on the basis of the drawings.

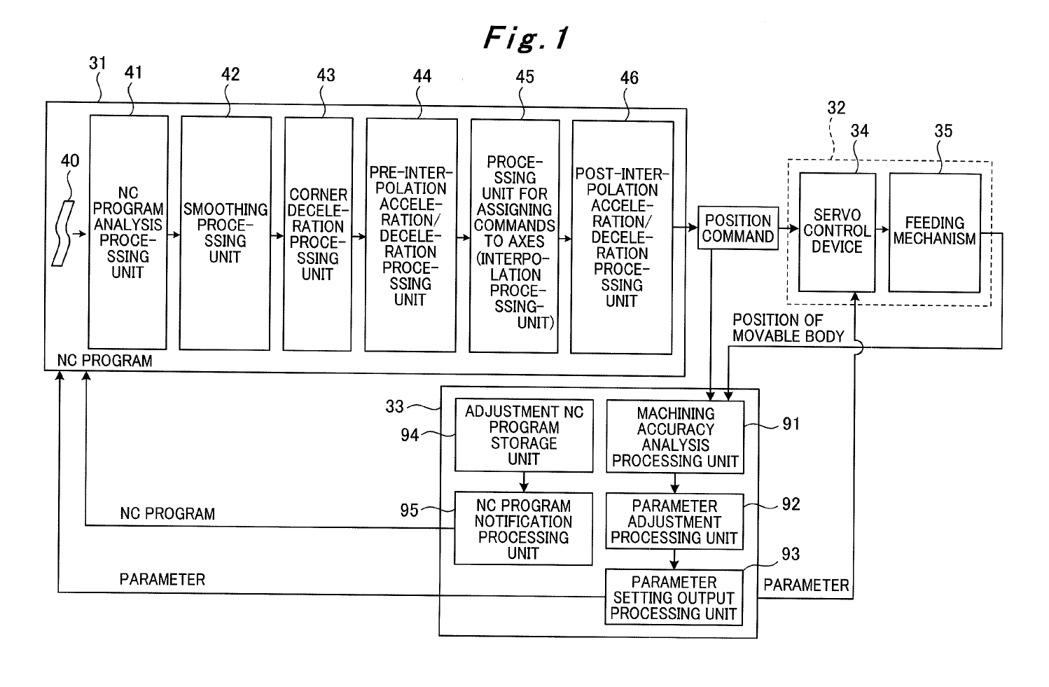

First, based on FIGS. 1 to 5, the description will be given of the configuration of an overall control system related to numerical control on a machine tool including a device for automatically adjusting a high-speed machining function and the like designed to implement a control parameter adjustment method of the embodiment of the present invention.

As shown in FIG. 1, the configuration of the overall control system related to the numerical control on the machine tool includes a numerical control device 31, a numerical control target 32 of the numerical control device 31, a device 33 for automatically adjusting the high-speed machining function, and the like. Moreover, the control target 32 includes a servo control device 34 as a control system, a feeding mechanism 35 as a mechanical system, and the like.

The numerical control device 31 is the same as the conventional one, and includes an NC (numerical control) program analysis processing unit 41, a smoothing processing unit 42, a corner deceleration processing unit 43, a pre-interpolation acceleration/deceleration processing unit 44, a processing unit 45 for assigning commands to the axes (interpolation processing unit), and a post-interpolation acceleration/deceleration processing unit 46.

The NC program analysis processing unit 41 is configured to read an NC program 40 registered in the numerical control device 31 and analyze an NC program command described in the read NC program 40. The NC program 40 registered in the numerical control device 31 includes not only a usual NC program for machining with the machine tool but also an adjustment NC program (details described later) for adjusting a control parameter.

The smoothing processing unit 42 is configured to perform correction/interpolation processing on the NC program command analyzed by the NC program analysis processing unit 41 to create a smooth move command.

The corner deceleration processing unit 43 is configured to figure out the command profile through look-ahead processing on the NC program 40, calculate the optimum speed in a corner portion of the command profile, and perform deceleration processing based thereon.

The pre-interpolation acceleration/deceleration processing unit 44 is configured to perform acceleration/deceleration processing on the move command of the NC program 40 before the processing unit 45 for assigning commands to the axes executes its processing.

The command assignment processing unit 45 is configured to assign move commands to the axes such as the X axis and the Y axis (interpolation processing). The post-interpolation acceleration/deceleration processing unit 46 performs acceleration/deceleration processing on the move commands assigned to the axes by the command assignment processing unit 45.

Then, a position command corresponding to the processing results is outputted to the servo control device 34 from the numerical control device 31.

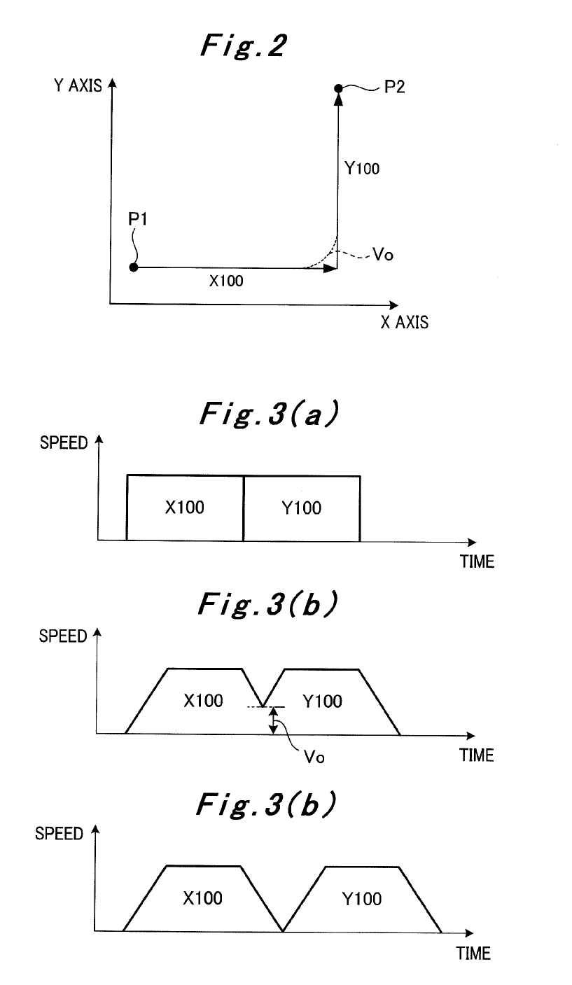

Based on FIGS. 2 and 3, a further description will be given of the overview of the processing of the corner deceleration processing unit 43 and of the pre-interpolation acceleration/deceleration processing unit 44. For example, in a case of moving the movable body in the X-axis direction and the Y-axis direction from a point P1 to a point P2 as shown in FIG. 2, the corresponding move command of the NC program 40 defines a profile as shown in Part (a) of FIG. 3. The pre-interpolation acceleration/deceleration processing unit 44 sets an acceleration/deceleration time constant for the rectangular move command (X100, Y100) and performs acceleration/deceleration processing based thereon. As a result, a move command allowing smooth acceleration and deceleration as shown in Part (b) of FIG. 3 is created.

Meanwhile, in this event, the move command may be configured such that the movement in the Y-axis direction starts after the movement in the X-axis direction ends as shown in Part (c) of FIG. 3. In this case, the movement path in a corner portion 50 forms a right angle as shown by the solid line in FIG. 2, hence increasing the machining time. In contrast, the movement in the Y-axis direction may be started before the movement in the X-axis direction ends. In this way, the movement path in the corner portion 50 curves as shown by the dotted line in FIG. 2, thereby allowing high-speed machining. Note that when the moving speed in the corner portion 50 is too fast, the impact on the movable body may be so large that the machining error may become extremely large (the machining accuracy may become extremely low) (thereby deforming the machined shape of the workpiece). For this reason, the corner deceleration processing unit 43 calculates an optimum speed Vo in the corner portion 50, and the pre-interpolation acceleration/deceleration processing unit 44 creates a move command as shown in Part (b) of FIG. 3 on the basis of the calculated optimum speed Vo.

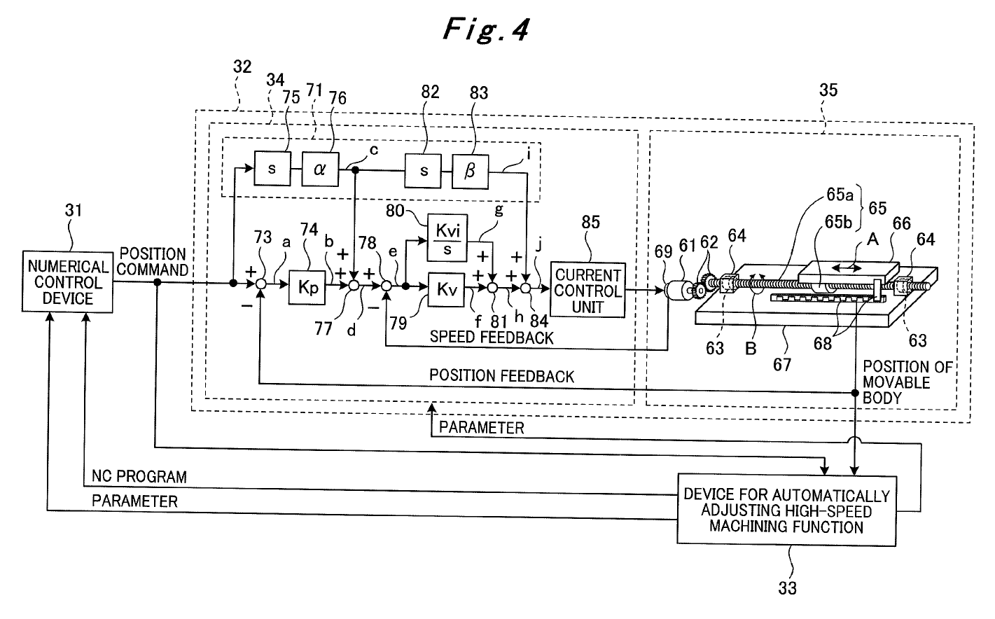

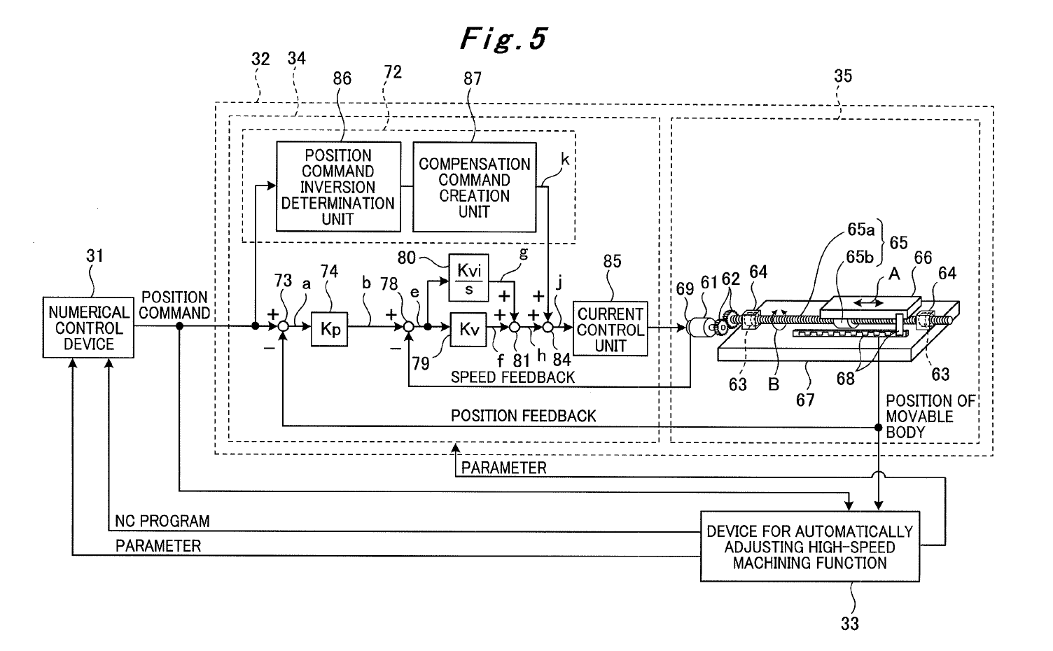

The servo control device 34 and the feeding mechanism 35 are configured as shown in FIG. 4 or 5. The feeding mechanisms 35 in both drawings are the same, but the servo control device 34 in FIG. 4 is one in which a feedforward control unit 71 is added whereas the servo control device 34 in FIG. 5 is one in which a quadrant glitch compensation unit 72 is added. Note that s in FIGS. 4 and 5 denotes a Laplace operator.

As shown in FIGS. 4 and 5, the feeding mechanism 35 is formed of a servomotor 61, reduction gears 62, support bearings 63, brackets 64, a ball screw 65 (screw portion 65a, nut portion 65b), and the like. The brackets 64 are fixed to a base 67, and the support bearings 63 are provided inside the brackets 64, respectively. The screw portion 65a of the ball screw 65 is supported rotatably on the support bearings 63 and screwed in the nut portion 65b of the ball screw 65 attached to a movable body 66 such as a table or a column. The servomotor 61 is coupled to the screw portion 65a through the reduction gears 62. A position detector (an inductosyn linear scale in the illustrated example) 68 is attached to the movable body 66, and a rotational speed detector (a pulse encoder in the illustrated example) 69 is attached to the servomotor 61.

Thus, the torque of the servomotor 61 is transmitted to the screw portion 65a of the ball screw 65 through the reduction gears 62 and rotates the screw portion 65a as shown by an arrow B, so that the movable body 66 (load inertia) moves straight as shown by an arrow A together with the nut portion 65b. In this event, the position detector 68 detects the moving position of the movable body 66, and the position detection signal is sent to the servo control device 34 from the position detector (position feedback). In addition, the rotational speed detector 69 detects the rotational speed of the servomotor 61, and the speed detection signal is sent to the servo control device 34 from the rotational speed detector 69 (speed feedback).

To describe the servo control device 34 in FIG. 4, an error calculation unit 73 finds a position error a by calculating the difference between the position command sent from the numerical control device 31 and the feedback signal from the position detector 68 representing the position of the movable body 66. A multiplication unit 74 multiplies the position error a by a position loop gain Kp to find a speed command b. Meanwhile, in the feedforward control unit 71, a differentiation unit 75 differentiates the position command, and a multiplication unit 76 multiplies this differential value by a position control loop lag compensation factor α to find a lag compensation value c. An addition unit 77 adds the lag compensation value c to the speed command b to find a compensated speed command d. An error calculation unit 78 calculates the difference between the speed command d and the feedback signal from the rotational speed detector 69 representing the rotational speed of the servomotor 61 to find a speed error e.

A proportion calculation unit 79 multiplies the speed error e by a speed loop proportional gain Kv to find a proportional value f. An integration unit 80 multiplies the speed error e by a speed loop integral gain Kvi and further integrates the product to find an integrated value g. An addition unit 81 adds the proportional value f to the integrated value g to find a torque command h. Meanwhile, in the feedforward control unit 71, a differentiation unit 82 differentiates the lag compensation value c. A multiplication unit 83 multiplies this differential value by a speed control loop lag compensation factor 13 to find a lag compensation value i. An addition unit 84 adds the lag compensation value i to the torque command h to find a compensated torque command j. A current control unit 85 controls the current to be supplied to the servomotor 61 such that the torque of the servomotor 61 would follow the torque command j.

Accordingly, by the servo control device 34 in FIG. 4, control is performed such that the rotational speed of the servomotor 61 follows the speed command d and that the moving position of the movable body 66 follows the position command. Further, the lags in these following operations are compensated by the feedforward control function.

To describe the servo control device 34 in FIG. 5, the quadrant glitch compensation unit 72 is such that if a position command inversion determination unit 86 determines that the position command is inversed, a compensation command creation unit 87 creates a compensation command k. Meanwhile, the error calculation unit 78 finds the speed error e by calculating the difference between the speed command b found by the multiplication unit 74 and the feedback signal from the rotational speed detector 69 representing the rotational speed of the servomotor 61. The addition unit 84 adds the compensation command k to the torque command h to find the compensated torque command j. The other parts are the same as those of the servo control device 34 in FIG. 5.

Accordingly, by the servo control device 34 in FIG. 5, control is performed such that the rotational speed of the servomotor 61 follows the speed command b and that the moving position of the movable body 66 follows the position command. Further, the lags (quadrant glitches) in these following operations are compensated by the quadrant glitch compensation function.

Moreover, the control system of this embodiment is provided with the device 33 for automatically adjusting the high-speed machining function (control parameter adjustment device), so as to manage changes over time in the control characteristics of some of the components of the feeding mechanism 35 (reduction gears 61, support bearings 63, ball screw 65) that are caused by wear and the like.

As shown in FIG. 1, the automatic adjustment device 33 includes a machining accuracy analysis processing unit 91, a parameter adjustment processing unit 92, a parameter setting output processing unit 93, an adjustment NC program storage unit 94, and an NC program notification processing unit 95.

The adjustment NC program storage unit 91 is configured to store therein NC programs for control parameter adjustment (hereinafter referred to as adjustment NC programs) in which commands for implementing the control parameter adjustment are described. The adjustment NC programs include a program for adjusting a control parameter related to the pre-interpolation acceleration/deceleration processing function (acceleration/deceleration time constant), a program for adjusting a control parameter related to the corner deceleration processing function (corner clamp acceleration), and the like. Specific examples of these will be described later.

From among the adjustment NC programs stored in the adjustment NC program storage unit 94, the NC program notification processing unit 95 selects and reads an adjustment NC program which the operator requests through an operation on an unillustrated operation unit, and then notifies the numerical control device 31 of the adjustment NC program. The numerical control device 31 in turn registers (stores) therein the adjustment NC program notified by the adjustment NC program storage unit 94. That is, the adjustment NC program is registered as the aforementioned NC program 40.

The numerical control device 31 executes the function of each of the aforementioned processing units 41 to 46 on the basis of the registered adjustment NC program 40 to create an adjustment position command, which is outputted to the servo control device 32 and also outputted to the machining accuracy analysis processing unit 91 of the automatic adjustment device 33. The servo control device 34 performs the feedback control such that the moving position of the movable body 66 would follow the adjustment position command. In this event, the feedback signal from the position detector 68 representing the position of the movable body 66 is fed back to the servo control device 34 and also outputted to the machining accuracy analysis processing unit 91 of the automatic adjustment device 33.

Then, the automatic adjustment device 33 adjusts the control parameter on the basis of the adjustment position command created based on the adjustment NC program and of the position of the movable body 66 detected by the position detector 68 (details of the adjustment method will be described later).

Specifically, the machining accuracy analysis processing unit 91 implements processing to analyze the machining accuracy on the basis of the adjustment position command and the position of the movable body 66; the parameter adjustment processing unit 92 adjusts the control parameter on the basis of the result of the analysis by the machining accuracy analysis processing unit 91; and the parameter setting output processing unit 93 outputs the control parameter adjusted by the parameter adjustment processing unit 92 to the numerical control device 31 and the servo control device 34.

The control parameters to be adjusted by the automatic adjustment device 33 are: an acceleration/deceleration time constant T(i) related to the pre-interpolation acceleration/deceleration processing function; and a corner clamp acceleration α(i) related to the corner deceleration processing function. The acceleration/deceleration time constant T(i) and the corner clamp acceleration α(i) are outputted to the numerical control device 31 from the automatic adjustment device 33. The automatic adjustment device 33, if necessary, may adjust a control parameter related to the feedforward control function, a control parameter related to the quadrant glitch compensation function, and a control parameter related to the post-interpolation acceleration/deceleration processing function. In such a case, the control parameters related to the feedforward control function and the quadrant glitch compensation function are outputted to the servo control device 34 from the automatic adjustment device 33, and the control parameter related to the post-interpolation acceleration/deceleration processing function is outputted to the numerical control device 31 from the automatic adjustment device 33.

(Method for Adjusting Acceleration/Deceleration Time Constant)

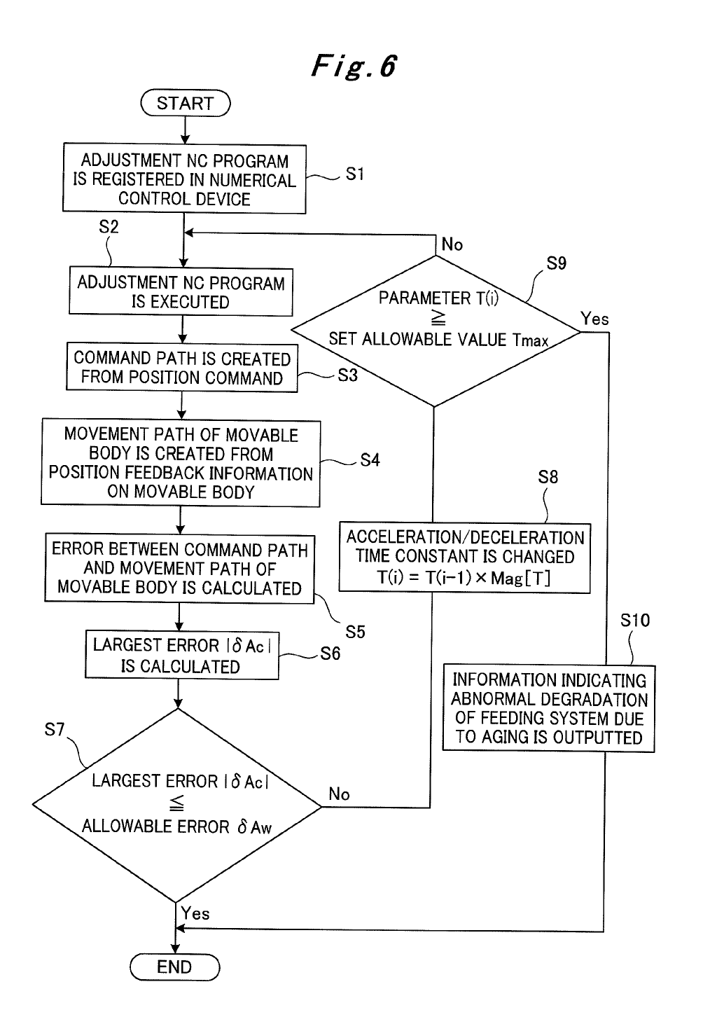

In the following, processing to adjust the acceleration/deceleration time constant T(i) will be described in detail on the basis of FIGS. 1 and 6 to 8. Note that the processing steps in the flowchart of FIG. 6 are denoted by reference signs steps S1 to S10, respectively.

First in step S1, an adjustment NC program is registered in the numerical control device 31.

Specifically, of the adjustment NC programs stored in the adjustment NC program storage unit 94, the NC program notification processing unit 95 reads an adjustment NC program for adjusting the acceleration/deceleration time constant T(i) for the pre-interpolation acceleration/deceleration processing function and notifies the numerical control device 31 of the read adjustment NC program. The numerical control device 31 in turn registers the adjustment NC program notified by the NC program notification processing unit 95.

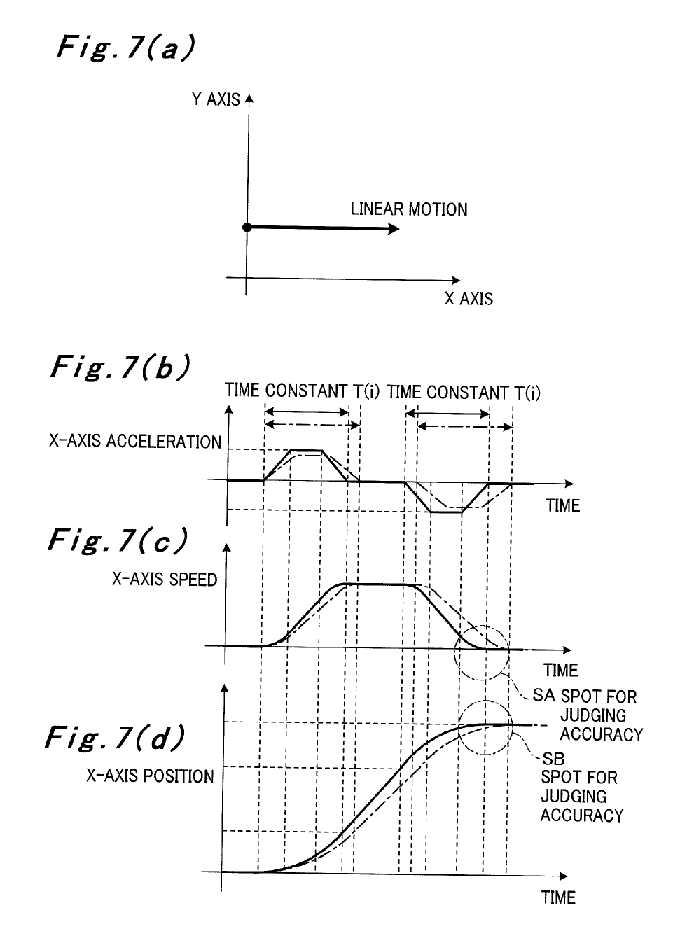

Note that the description will be given in this section by taking an example where the feeding mechanism 35 to be subjected to the control parameter adjustment for the pre-interpolation acceleration/deceleration processing function is an X-axis feeding mechanism. In this case, the adjustment NC program for the pre-interpolation acceleration/deceleration processing function has a move command described therein which causes the movable body 66 to move straight (linear motion) in the X-axis direction as shown in Part (a) of FIG. 7.

Next, in step S2, the adjustment NC program is executed.

Specifically, the numerical control device 31 executes the function of each of the processing units 41 to 46 on the basis of the registered adjustment NC program for the pre-interpolation acceleration/deceleration processing function to create an adjustment position command and outputs this adjustment position command to the servo control device 32. Parts (b) to (d) of FIG. 7 show example profiles of the adjustment command for the pre-interpolation acceleration/deceleration processing function in this step. Parts (b) to (d) of FIG. 7 respectively show the X-axis acceleration (the acceleration of the movement of the movable body 66 in the X-axis direction), the X-axis speed (the speed of the movement of the movable body 66 in the X-axis direction), and the X-axis position (the moving position of the movable body 66 in the X-axis direction) all of which correspond to a predetermined acceleration/deceleration time constant T(i). The adjustment position command outputted to the servo control device 34 from the numerical control device 31 corresponds to the X-axis position in Part (d) of FIG. 7.

Next, in step S3, a command path is created from the position command. Then, in step S4, the movement path of the movable body is created from the position feedback information on the movable body.

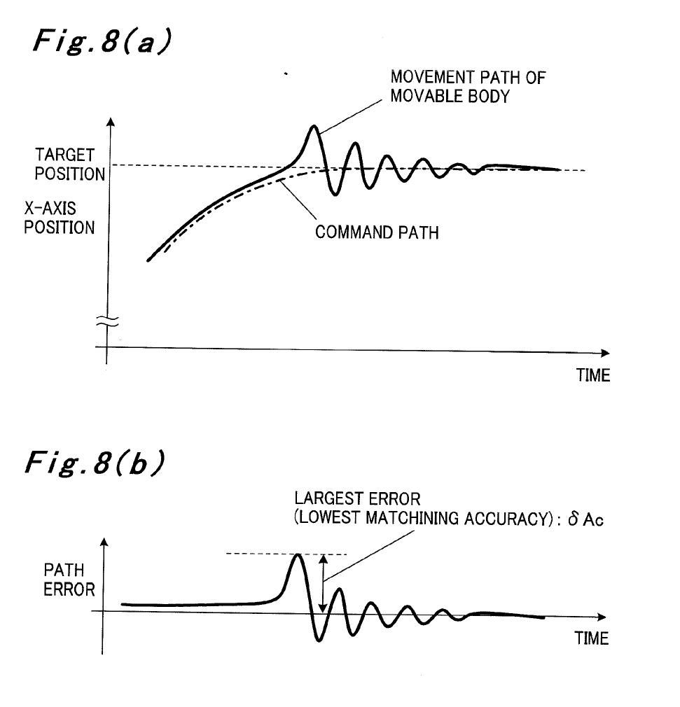

Specifically, the machining accuracy analysis processing unit 91 creates a command path as shown by the dashed line in Part (a) of FIG. 8 on the basis of the adjustment position command inputted from the numerical control device 31. The machining accuracy analysis processing unit 91 also creates the movement path of the movable body 66 as shown by the solid line in Part (a) of FIG. 8 on the basis of the position of the movable body 66 inputted from the position detector 68. The spot for judging the machining accuracy is a portion SA in Part (c) of FIG. 7 and a portion SB in Part (d) of FIG. 7, and the command path shown in Part (a) of FIG. 8 is the path in the portion SB in Part (d) of FIG. 7.

Next, in step S5, the error between the command path and the movement path of the movable body 66 is calculated. Then, in step S6, the largest error (lowest machining accuracy) |δAc| is calculated. Moreover, in step S7, the largest error |δAc| (μm) and an allowable error (allowable machining accuracy) δAw (μm) are compared with each other to judge whether or not the largest error |δAc| is equal to or smaller than the allowable error δAw (|δAc|≦δAw).

Specifically, the machining accuracy analysis processing unit 91 calculates the difference (path error) between the command path created in step S3 and the movement path created in step S4 to find path errors as shown in Part (b) of FIG. 8 and also to find the largest error |δAc| in the path errors. The largest error is described here as an absolute value because both positive and negative values may be present in the difference between the command path and the movement path. The machining accuracy analysis processing unit 91 then judges whether or not the largest error |δAc| found in step S5 is equal to or smaller than the allowable error δAw (|δAc|≦δAw).

Note that the command path and the movement path may not necessarily have to be created. The creation of these paths may be omitted, and the adjustment position command inputted from the numerical control device 31 and the position of the movable body 66 inputted from the position detector 68 may be directly compared with each other to find the difference therebetween, and the largest valve in the difference may be set as the largest error |δAc|.

In step S7, if the largest error |δAc| is judged as equal to or smaller than the allowable error δAw (|δAc|≦δAw) (YES), this means that the machining accuracy is good and the acceleration/deceleration time constant T(i) does not need to be adjusted (no further adjustment is necessary). Thus, the adjustment processing is terminated. On the other hand, if the largest error |δAc| is judged in step S7 as greater than the allowable error δAw (|δAc|>δAw) (NO), this means that the machining accuracy is poor and the acceleration/deceleration time constant T(i) needs to be adjusted. Thus, the adjustment processing proceeds to step S8.

In step S8, the parameter adjustment processing unit 92 performs a calculation using a formula (1) given below to change the acceleration/deceleration time constant T(i) (msec). In the formula (1), T(i−1) represents the last value of the acceleration/deceleration time constant T(i) (the initial value or the last changed value). Mag[T] represents a parameter change rate and is set to a value greater than 1.0 (Mag[T]>1.0). To improve the machining accuracy, the acceleration/deceleration time constant T(i) needs to be increased to make the acceleration and deceleration of the movable body 66 gentle. For this reason, the parameter change rate Mag[T] is set to a value greater than 1. Note that a specific value of Mag[T] may be set appropriately through tests and analyses.

T(i)=T(i−1)×Mag[T] (1)

Instep S9, the parameter setting output processing unit 93 compares the acceleration/deceleration time constant T(i) (msec) and a set allowable value (maximum allowable time constant) Tmax (msec) to judge whether or not the acceleration/deceleration time constant T(i) is equal to or greater than the set allowable value Tmax (T(i)≧Tmax).

If the acceleration/deceleration time constant T(i) changed in step S8 is judged in step S9 as smaller than the set allowable value Tmax (T(i)<Tmax), the changed acceleration/deceleration time constant T(i) is outputted to the numerical control device 31 from the parameter setting output processing unit 93, and the adjustment processing returns to step S2.

Thereafter, the processes in steps S2 to S9 are iterated until the largest error |δAc| is judged as equal to or smaller than the allowable error δAw (|δAc|≦δAw) in step S7 (i.e., until the adjustment of the control parameter T(i) is completed). In this iteration, in the execution of the adjustment NC program in step S2, the pre-interpolation acceleration/deceleration processing unit 44 executes the acceleration/deceleration processing on the basis of the acceleration/deceleration time constant T(i) changed in step S8. Since the acceleration/deceleration time constant T(i) is changed in step S8 to a value greater than the last value thereof, the profile of the adjustment command for the pre-interpolation acceleration/deceleration processing function is changed from the state shown by the solid lines in Parts (b) to (d) of FIG. 7 to a state as shown by the dashed lines in Parts (b) to (d) of FIG. 7, for example. Accordingly, the acceleration and deceleration of the movable body 66 become gentler, reducing the impact thereon. As a result, the machining accuracy is improved.

On the other hand, in step S9, if the changed acceleration/deceleration time constant T(i) is judged as equal to or greater than the set allowable value Tmax (T(i)≧Tmax), the adjustment processing proceeds to step S10. In step S10, information indicating abnormal degradation of the feeding system due to aging thereof is outputted to abnormality alarming means (unillustrated), and then the adjustment processing as terminated.

Specifically, the parameter setting output processing unit 93 outputs an abnormality detection signal, which notifies that the degradation of the feeding mechanism 66 due to the aging thereof is abnormal, to the unillustrated abnormality alarming means (e.g., alarm lamp, alarm buzzer, display, etc.) if the changed acceleration/deceleration time constant T(i) is judged as equal to or greater than the set allowable value Tmax (T(i)≧Tmax), i.e., if the aging of the feeding mechanism 35 has reached or exceeded an allowable level. Upon input of the abnormality detection signal, the abnormality alarming means informs the operator of the abnormal degradation of the feeding mechanism 66 (e.g., turning on the alarm lamp, actuating the alarm buzzer, displaying information on the display, etc.). A specific value of the set allowable value Tmax may be set appropriately through tests and analyses.

Note that although the description has been given above of the method for adjusting the control parameter T(i) related to the numerical control on an X-axis feeding mechanism, the adjustment method is not limited to this as a matter of course. The adjustment method is applicable to the adjustment of a control parameter T(i) related to numerical control on a feeding mechanism designed for a different moving axis (such as the Y axis or the Z axis).

Moreover, the adjustment method is applicable not only to linear movement but also to a case where the servo control device performs feedback control such that the position (rotational angle) of the table about its rotational axis (C axis) would follow a position command (rotation command) from the numerical control device. In this case, the rotation command is the rotational angle about the rotational axis; the vertical axis in Part (b) of FIG. 7 is the acceleration (angular acceleration) of rotation about the rotational axis; the vertical axis in Part (c) of FIG. 7 is the speed of the rotation about the rotational axis; and the vertical axis in Part (d) of FIG. 7 is the angle of the rotation about the rotational axis.

(Method for Adjusting Corner Clamp Acceleration)

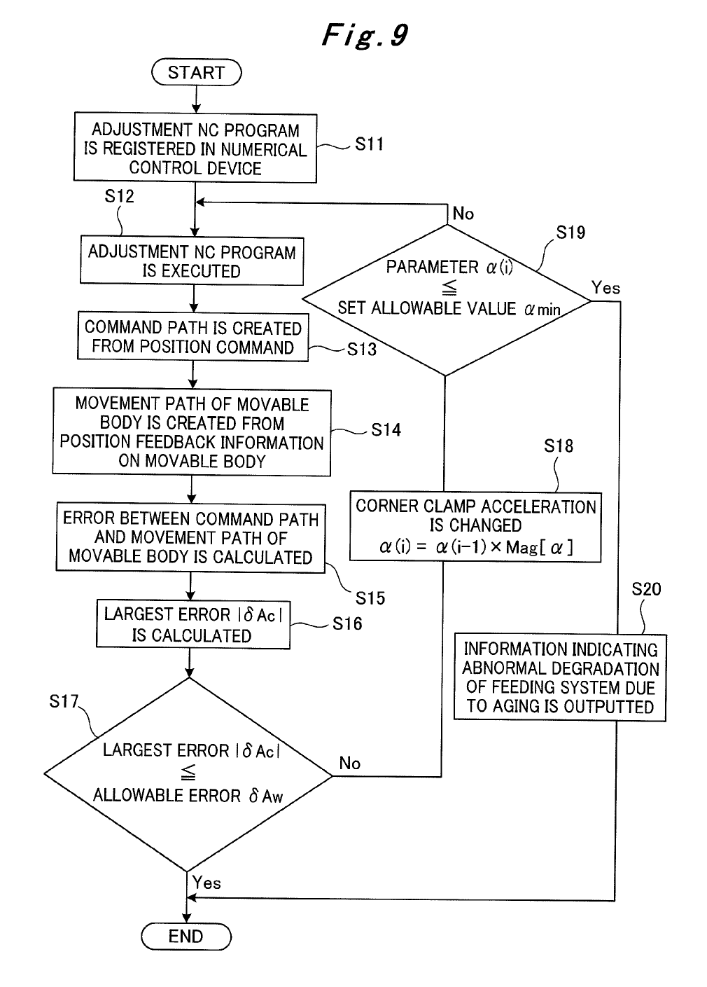

Next, a method for adjusting the corner clamp acceleration α(i) will be described in detail on the basis of FIGS. 1 and 9 to 11. Note that the processing steps in the flowchart of FIG. 9 are denoted by reference signs steps S11 to S20, respectively.

First, in step S11, an adjustment NC program is registered in the numerical control device 31.

Specifically, of the adjustment NC programs stored in the adjustment NC program storage unit 94, the NC program notification processing unit 95 reads an adjustment NC program for adjusting the corner clamp acceleration α(i) for the corner deceleration processing function and notifies the numerical control device 31 of the read adjustment NC program. The numerical control device 31 in turn registers the adjustment NC program notified by the NC program notification processing unit 95.

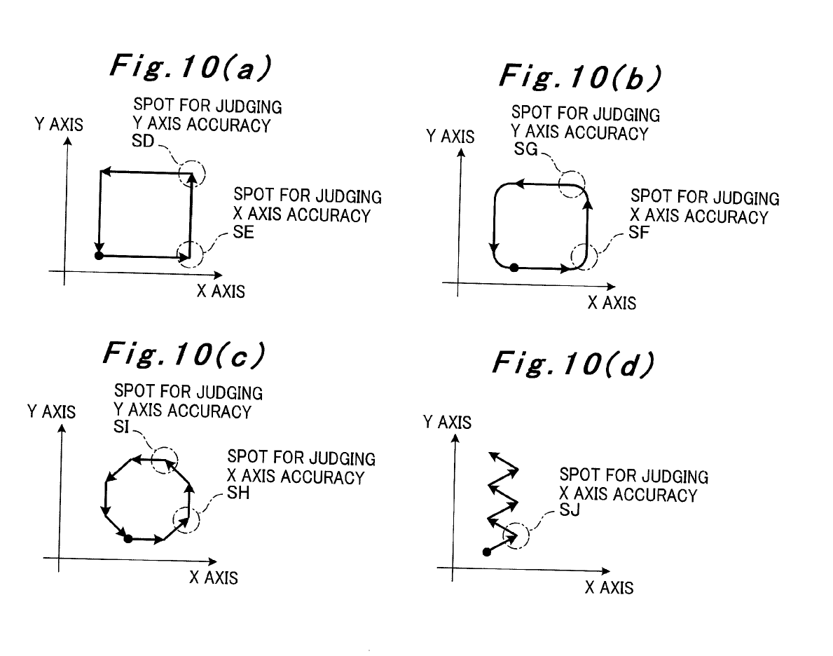

Note that the description will be given in this section by taking an example where the feeding mechanism 35 to be subjected to the control parameter adjustment for the corner deceleration processing function includes an X-axis feeding mechanism and a Y-axis feeding mechanism. In this case, the adjustment NC program for the corner deceleration processing function has move commands described therein which include corner portions as shown in Parts (a) to (d) of FIG. 10, for example.

The adjustment command in Part (a) of FIG. 10 has a rectangular profile in which a portion SE is a spot for judging the X-axis accuracy while a portion SD is a spot for judging the Y-axis accuracy. The adjustment command in Part (b) of FIG. 10 has a rectangular profile with round corners in which a portion SF is a spot for judging the X-axis accuracy while a portion SG is a spot for judging the Y-axis accuracy. The adjustment command in Part (c) of FIG. 10 has an octagonal profile in which a portion SH is a spot for judging the X-axis accuracy while a portion SI is a spot for judging the Y-axis accuracy. The adjustment command in Part (d) of FIG. 10 has a zigzag profile in which a portion SJ is a spot for judging the X-axis accuracy (Part (d) of FIG. 10 is rotated 90 degrees for judging the Y-axis accuracy).

Next, in step S12, the adjustment NC program is executed.

Specifically, the numerical control device 31 executes the function of each of the processing units 41 to 46 on the basis of the registered adjustment NC program for the corner deceleration processing function to create an adjustment position command and outputs this adjustment position command to the servo control device 32.

Next, in step S13, a command path is created from the position command. Then, in step S14, the movement path of the movable body is created from the position feedback information on the movable body.

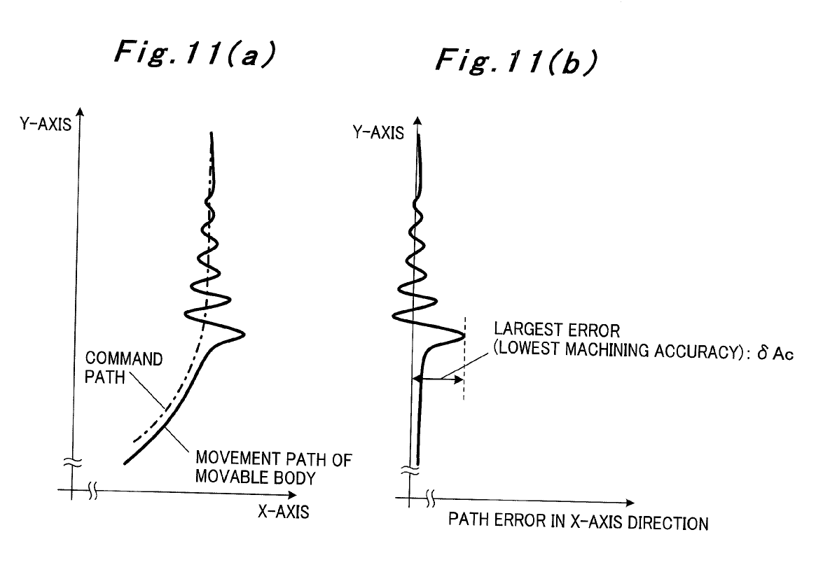

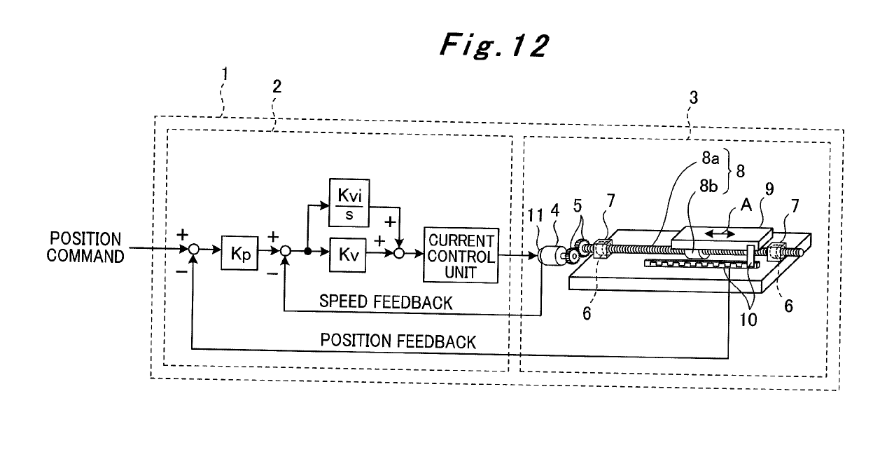

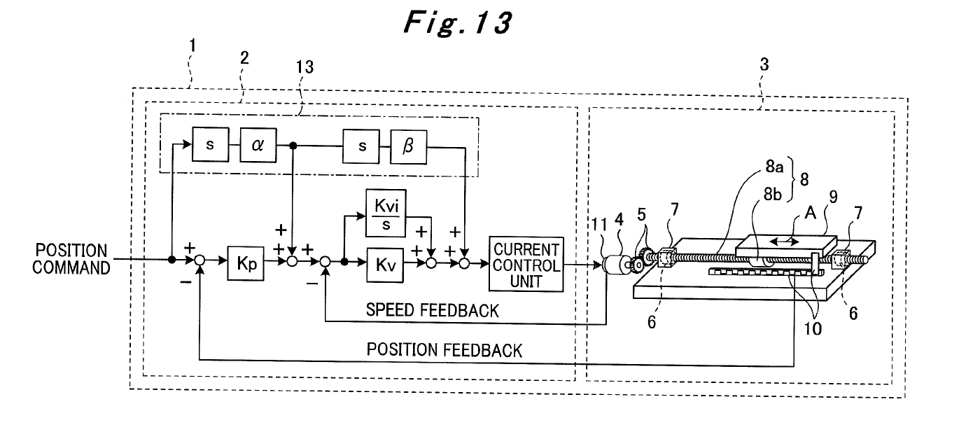

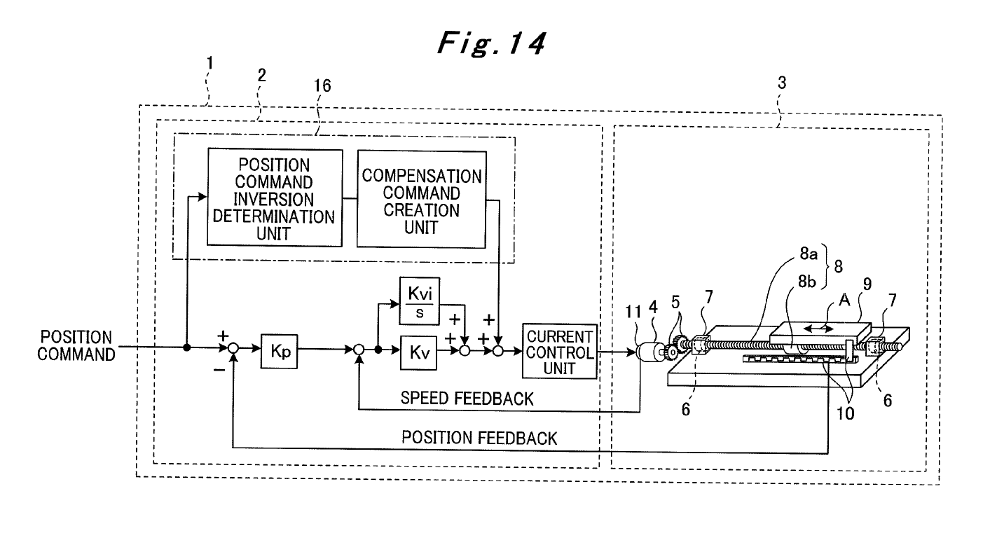

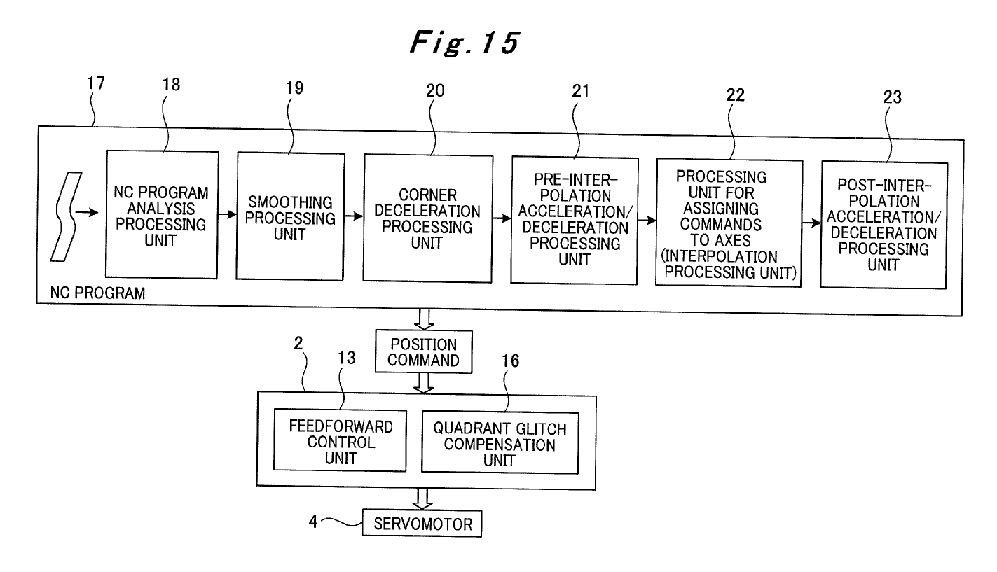

Specifically, the machining accuracy analysis processing unit 91 creates a command path as shown by the dashed line in Part (a) of FIG. 11 on the basis of the adjustment position command (X-axis position command, Y-axis position command) inputted from the numerical control device 31. The machining accuracy analysis processing unit 91 also creates the movement path of the movable body 66 as shown by the solid line in Part (a) of FIG. 11 on the basis of the position (X-axis position, Y-axis position) of the movable body 66 inputted from the position detector 68. Note that Part (a) of FIG. 11 illustrates a path corresponding to the portion SF in the adjustment command profile in Part (b) of FIG. 10 (the spot for judging the X-axis accuracy).

Next, in step S15, the error between the command path and the movement path of the movable body 66 is calculated. Then, in step S16, a largest error (lowest machining accuracy) |δAc| is calculated. Moreover, in step S17, the largest error |δAc| (μm) and an allowable error (allowable machining accuracy) δAw (μm) are compared with each other to judge whether or not the largest error |δAc| is equal to or smaller than the allowable error δAw (|δAc|≦δAw).

Specifically, the machining accuracy analysis processing unit 91 calculates the difference (path error) between the command path created in step S13 and the movement path created in step S14 to find path errors in the X-axis direction as shown in Part (b) of FIG. 11, for example, and also to find the largest error |δAc| in the path errors. The largest error is described here as an absolute value because both positive and negative values may be present in the difference between the command path and the movement path. The machining accuracy analysis processing unit 91 then judges whether or not the largest error |δAc| found in step S15 is equal to or smaller than the allowable error δAw (|δAc|≦δAw).

Note that the command path and the movement path may not necessarily have to be created. The creation of these paths may be omitted, and the adjustment position command inputted from the numerical control device 31 and the position of the movable body 66 inputted from the position detector 68 may be directly compared with each other to find the difference therebetween, and the largest valve in the difference may be set as the largest error |δAc|.

In step S17, if the largest error |δAc| is judged as equal to or smaller than the allowable error δAw (|δAc|≦δAw) (YES), this means that the machining accuracy is good and the corner clamp acceleration α(i) does not need to be adjusted (no further adjustment is necessary). Thus, the adjustment processing is terminated. On the other hand, if the largest error |δAc| is judged in step S17 as greater than the allowable error δAw (|δAc|>δAw) (NO), this means that the machining accuracy is poor and the corner clamp acceleration α(i) needs to be adjusted. Thus, the adjustment processing proceeds to step S18.

In step S18, the parameter adjustment processing unit 92 performs a calculation using a formula (2) given below to change the corner clamp acceleration α(i) (m/sec²). In the formula (2), α(i−1) represents the last value of the corner clamp acceleration α(i) (the initial value or the last changed value). Mag[α] represents a parameter change rate and is set to a value smaller than 1.0 (Mag[α]<1.0).

Assume that the curvature radius of the movement path of a corner portion (e.g., the portion SF in Part (b) of FIG. 10, or the like) is R (fixed value), and the moving speed in the corner portion is V. In this case, the corner clamp acceleration α(i) produced in the movement within the corner portion at the speed V can be expressed as α(i)=V²/R. To improve the machining accuracy, since the curvature radius R is fixed, the corner clamp acceleration α(i) needs to be reduced to decrease the moving speed V of the movable body 66 in the corner portion. For this reason, the parameter change rate Mag[α] is set to a value smaller than 1. Note that a specific value of Mag[α] may be set appropriately through tests and analyses.

α(i)=α(i−1)×Mag[α] (2)

In step S19, the parameter setting output processing unit 93 compares the corner clamp acceleration α(i) (m/sec²) and a set allowable value (minimum allowable acceleration) αmin (m/sec²) to judge whether or not the corner clamp acceleration α(i) is equal to or smaller than the set allowable value αmin (α(i)≦αmin).

If the corner clamp acceleration α(i) changed in step S18 is judged in step S19 as greater than the set allowable value αmin (α(i)>αmin), the changed acceleration/deceleration time constant α(i) is outputted to the numerical control device 31 from the parameter setting output processing unit 93, and the adjustment processing returns to step S12.

Thereafter, the processes in steps S12 to S19 are iterated until the largest error |δAc| is judged as equal to or smaller than the allowable error δAw (|δAc|≦δAw) in step S17 (i.e., until the adjustment of the control parameter α(i) is completed). In this iteration, in the execution of the adjustment NC program in step S12, the corner deceleration processing unit 43 executes the corner deceleration processing on the basis of the corner clamp acceleration α(i) changed in step S18. Accordingly, the moving speed V of the movable body 66 in the corner portion becomes slower, improving the X-axis machining accuracy.

On the other hand, in step S19, if the changed corner clamp acceleration α(i) is judged as equal to or smaller than the set allowable value αmin (α(i)≦αmin), the adjustment processing proceeds to step S20. In step S20, information indicating abnormal degradation of the feeding system due to aging thereof is outputted to the abnormality alarming means (unillustrated), and then the adjustment processing is terminated.

Specifically, the parameter setting output processing unit 93 outputs an abnormality detection signal, which notifies that the degradation of the feeding mechanism 66 due to the aging thereof is abnormal, to the unillustrated abnormality alarming means (e.g., alarm lamp, alarm buzzer, display, etc.) if the changed corner clamp acceleration α(i) is judged as equal to or smaller than the set allowable value αmin (α(i)≦αmin), i.e., if the aging of the feeding mechanism 35 has reached or exceeded an allowable level. Upon input of the abnormality detection signal, the abnormality alarming means informs the operator of the abnormal degradation of the feeding mechanism 66 (e.g., turning on the alarm lamp, actuating the alarm buzzer, displaying information on the display, etc.). A specific value of the set allowable value αmin may be set appropriately through tests and analyses.

Note that although described above is for the X-axis direction, the method for adjusting the control parameter (corner clamp acceleration α(i)) related to the Y-axis machining accuracy is the same as that of the X-axis.

Moreover, although the description has been given above by taking an example where the feeding mechanism 35 to be subjected to the control parameter adjustment for the corner deceleration processing function includes an X-axis feeding mechanism and a Y-axis feeding mechanism, the adjustment method is not limited to this as a matter of course. The adjustment method is applicable to the adjustment of a control parameter α(i) related to numerical control on a feeding mechanism designed for different moving axes (such as the X and Z axes perpendicular to each other, the Y and Z axes perpendicular to each other, or X, Y, and Z axes perpendicular to each other).

A control parameter (acceleration/deceleration time constant) adjustment method of the embodiment described above is used in a control system in which a servo control device 34 performs feedback control on a feeding mechanism 35 in such a way that a position of a movable body 66 (the moving position in the case of straight movement in the X axis direction or the like; the rotational position (rotational angle) in the case of rotation about the rotational axis) moved by the feeding mechanism 35 follows a position command (command for the moving position in the case of straight movement in the X axis direction or the like; command for the rotational position (rotational angle) in the case of rotation about the rotational axis) outputted from a numerical control device 31, the control parameter adjustment method being used for adjusting an acceleration/deceleration time constant T(i) being a control parameter related to a pre-interpolation acceleration/deceleration processing function of the numerical control device 31, the control parameter adjustment method characterized in that the control parameter adjustment method comprises performing: first processing (step S1) to notify the numerical control device 31 of an adjustment NC program and register the adjustment NC program in the numerical control device 31; second processing (step S2) to cause the numerical control device 31 to execute the adjustment NC program to output an adjustment position command (command for the moving position in the case of straight movement in the X axis direction or the like; command for the rotational position (rotational angle) in the case of rotation about the rotational axis); third processing (steps S3 to S6) to find a largest error |δAc| being a largest value in a difference between the adjustment position command and the position of the movable body 66 (the moving position in the case of straight movement in the X axis direction or the like; the rotational position (rotational angle) in the case of rotation about the rotational axis) fed back from a position detector 68 (detector for the moving position in the case of straight movement in the X axis direction or the like; detector for the rotational position (rotational angle) in the case of rotation about the rotational axis) of the movable body 66, the position of the movable body 66 being fed back when the servo control device 34 performs feedback control on the feeding mechanism 35 in such a way that the position of the movable body 66 (the moving position in the case of straight movement in the X axis direction or the like; the rotational position (rotational angle) in the case of rotation about the rotational axis) follows the adjustment position command; fourth processing (steps S7 to S9) to judge whether or not the largest error |δAc| is equal to or smaller than an allowable error δAw, change the acceleration/deceleration time constant T(i) to a larger value if the largest error |δAc| is judged as greater than the allowable error δAw, and output the changed acceleration/deceleration time constant T(i) to the numerical control device 31, and the second processing, the third processing, and the fourth processing (steps S2 to S9) are iterated until the largest error |δAc| is judged as equal to or smaller than the allowable error δAw in the fourth processing.

A control parameter (corner clamp acceleration) adjustment method of the embodiment is used in a control system in which a servo control device 34 performs feedback control on a feeding mechanism 35 in such a way that a position of a movable body moved by the feeding mechanism 35 follows a position command outputted from a numerical control device 31, the control parameter adjustment method being used for adjusting a corner clamp acceleration α(i) being a control parameter related to a corner deceleration processing function of the numerical control device 31, the control parameter adjustment method characterized in that the control parameter adjustment method comprises the steps of: performing first processing (step S11) to notify the numerical control device 31 of an adjustment NC program and register the adjustment NC program in the numerical control device 31; performing second processing (step S12) to cause the numerical control device 31 to execute the adjustment NC program to output an adjustment position command; performing third processing (steps S13 to S16) to find a largest error |δAc| being a largest value in a difference between the adjustment position command and the position of the movable body 66 fed back from a position detector 68 of the movable body 66, the position of the movable body 66 being fed back when the servo control device 34 performs feedback control on the moving mechanism 66 in such away that the position of the movable body 66 follows the adjustment position command; performing fourth processing (steps S17 to S19) to judge whether or not the largest error |δAc| is equal to or smaller than an allowable error δAw, change the corner clamp acceleration α(i) to a smaller value if the largest error |δAc| is judged as greater than the allowable error δAw, and output the changed corner clamp acceleration α(i) to the numerical control device 31; and iterating the second processing, the third processing, and the fourth processing (steps S12 to S19) until the largest error |δAc| is judged as equal to or smaller than the allowable error δAw in the fourth processing.

An automatic adjustment device 33 (adjustment device for control parameter (acceleration/deceleration time constant)) of the embodiment is used in a control system in which a servo control device 34 performs feedback control on a feeding mechanism 35 in such a way that a position of a movable body 66 (the moving position in the case of straight movement in the X axis direction or the like; the rotational position (rotational angle) moved by the feeding mechanism 35 follows a position command (command for the moving position in the case of straight movement in the X axis direction or the like; command for the rotational position (rotational angle) in the case of rotation about the rotational axis) outputted from a numerical control device 31, the automatic adjustment device 33 being used for adjusting an acceleration/deceleration time constant T(i) being a control parameter related to a pre-interpolation acceleration/deceleration processing function of the numerical control device 31, the automatic adjustment device 33 characterized in that the automatic adjustment device 33 comprises: an adjustment NC program storage unit 94 configured to store an adjustment NC program; an NC program notification processing unit 95 configured to read the adjustment NC program from the adjustment NC program storage unit 94 and notify the numerical control device 31 of the adjustment NC program; a machining accuracy analysis processing unit 91 configured to find a largest error |δAc| being a largest value in a difference between an adjustment position command (command for the moving position in the case of straight movement in the X axis direction or the like; command for the rotational position (rotational angle) in the case of rotation about the rotational axis) and the position of the movable body 66 (the moving position in the case of straight movement in the X axis direction or the like; the rotational position (rotational angle) in the case of rotation about the rotational axis) and judge whether or not the largest error |δAc| is equal to or smaller than an allowable error δAw, the adjustment position command being outputted from the numerical control device 31 by executing the adjustment NC program, the position of the movable body 66 being fed back from a position detector 68 of the movable body 66 when the servo control device 34 performs feedback control on the feeding mechanism 35 in such a way that the position of the movable body 66 (the moving position in the case of straight movement in the X axis direction or the like; the rotational position (rotational angle) in the case of rotation about the rotational axis) follows the adjustment position command; a parameter adjustment processing unit 92 configured to change the acceleration/deceleration time constant T(i) to a larger value if the machining accuracy analysis processing unit 91 judges that the largest error |δAc| is greater than the allowable error δAw; and a parameter setting output processing unit 93 configured to output the acceleration/deceleration time constant T(i) changed by the parameter adjustment processing unit 92 to the numerical control device 31.

An automatic adjustment device 33 (adjustment device for control parameter (corner clamp acceleration)) of the embodiment is used in a control system in which a servo control device 34 performs feedback control on a feeding mechanism 35 in such a way that a position of a movable body 66 moved by the feeding mechanism 35 follows a position command outputted from a numerical control device 31, the automatic adjustment device 33 being used for adjusting a corner clamp acceleration α(i) being a control parameter related to a corner deceleration processing function of the numerical control device 31, the automatic adjustment device 33 characterized in that the automatic adjustment device 33 comprises: an adjustment NC program storage unit 94 configured to store an adjustment NC program; an NC program notification processing unit 95 configured to read the adjustment NC program from the adjustment NC program storage unit 94 and notify the numerical control device 31 of the adjustment NC program; a machining accuracy analysis processing unit 91 configured to find a largest error |δAc| being a largest value in a difference between an adjustment position command and the position of the movable body 66 and judge whether or not the largest error |δAc| is equal to or smaller than an allowable error δAw, the adjustment position command being outputted from the numerical control device 31 by executing the adjustment NC program, the position of the movable body 66 being fed back from a position detector 68 of the movable body 66 when the servo control device 34 performs feedback control on the feeding mechanism 35 in such a way that the position of the movable body 66 follows the adjustment position command; a parameter adjustment processing unit 92 configured to change the corner clamp acceleration α(i) to a smaller value if the machining accuracy analysis processing unit 91 judges that the largest error |δAc| is greater than the allowable error δAw; and a parameter setting output processing unit 93 configured to output the corner clamp acceleration α(i) changed by the parameter adjustment processing unit 92 to the numerical control device 31.

Accordingly, with the control parameter adjustment method or the automatic adjustment device 33 (control parameter adjustment device) of this embodiment, effects (1) to (4) described below can be achieved. Moreover, an effect (5) described below can be obtained since the control parameter adjustment method and the automatic adjustment device 33 (control parameter adjustment device) of this embodiment are characterized in that: the information indicating abnormal degradation of the feeding mechanism 35 is outputted to the abnormality alarming means when the changed acceleration/deceleration time constant T(i) is judged as having reached or exceeded the set allowable value Tmax; and the information indicating abnormal degradation of the feeding mechanism 35 is outputted to the abnormality alarming means when the changed corner clamp acceleration α(i) is judged as having reached or fallen below the set allowable value αmin.

(1) Change in the position accuracy of a feeding mechanism 35 (machining accuracy in a case of a machine tool) over time can be figured out.

(2) A desired position accuracy (machining accuracy) can be achieved automatically even in a case of a feeding mechanism 35 experiencing aging.

(3) The position accuracy (machining accuracy) can be maintained as high as the brand new level without performing a repair work (maintenance) and the like of the feeding mechanism 35 for a long period of time.

(4) The maintenance service cost can be reduced since the position accuracy (machining accuracy) of the feeding mechanism 35 can be maintained at a high level for a long period of time without maintenance.

(5) The degree of aging (the degree of degradation) of the feeding mechanism 35 can be automatically detected since the position accuracy (machining accuracy) of the feeding mechanism 35 is automatically figured out.

Note that although the description has been given above of the adjustment of control parameters related to numerical control on a feeding mechanism of a machine tool, the present invention is not limited to this. The control parameter adjustment method of the present invention is applicable to the adjustment of control parameters related to numerical control on moving mechanisms of other industrial machines than machine tools.

### INDUSTRIAL APPLICABILITY

The present invention relates to a control parameter adjustment method and an adjustment device and is suitably applied to numerical control on movement of a movable body through a moving mechanism such as a feeding mechanism in an industrial machine such as a machine tool.

### EXPLANATION OF REFERENCE NUMERALS

31 numerical control device
32 control target
33 device for automatically adjusting high-speed machining function
34 servo control device
35 feeding mechanism
40 NC program (adjustment NC program)
41 NC program analysis processing unit
42 smoothing processing unit
43 corner deceleration processing unit
44 pre-interpolation acceleration/deceleration processing unit
45 processing unit for assigning commands to axes
46 post-interpolation acceleration/deceleration processing unit
61 servomotor
62 reduction gear
63 support bearing
64 bracket
65 ball screw
65a screw portion
65b nut portion
66 movable body
67 base
68 position detector
69 rotational speed detector
71 feedforward control unit
72 quadrant glitch compensation unit
73 error calculation unit
74 multiplication unit
75 differentiation unit
76 multiplication unit
77 addition unit
78 error calculation unit
79 proportion calculation unit
80 integration unit
81 addition unit
82 differentiation unit
83 multiplication unit
84 addition unit
85 current control unit
86 position command inversion determination unit
87 compensation command creation unit
91 machining accuracy analysis processing unit
92 parameter adjustment processing unit
93 parameter setting output processing unit
94 adjustment NC program storage unit
95 NC program notification processing unit

1. A control parameter adjustment method used in a control system in which a servo control device performs feedback control on a moving mechanism in such away that a position of a movable body moved by the moving mechanism follows a position command outputted from a numerical control device, the control parameter adjustment method being used for adjusting an acceleration/deceleration time constant being a control parameter related to a pre-interpolation acceleration/deceleration processing function of the numerical control device, the control parameter adjustment method characterized in that
the control parameter adjustment method comprises performing:
first processing to notify the numerical control device of an adjustment NC program and register the adjustment NC program in the numerical control device;
second processing to cause the numerical control device to execute the adjustment NC program to output an adjustment position command;
third processing to find a largest error being a largest value in a difference between the adjustment position command and the position of the movable body fed back from a position detector of the movable body, the position of the movable body being fed back when the servo control device performs feedback control on the moving mechanism in such a way that the position of the movable body follows the adjustment position command; and
fourth processing to judge whether or not the largest error is equal to or smaller than an allowable error, change the acceleration/deceleration time constant to a larger value if the largest error is judged as greater than the allowable error, and output the changed acceleration/deceleration time constant to the numerical control device, and
the second processing, the third processing, and the fourth processing are iterated until the largest error is judged as equal to or smaller than the allowable error in the fourth processing.

2. A control parameter adjustment method used in a control system in which a servo control device performs feedback control on a moving mechanism in such a way that a position of a movable body moved by the moving mechanism follows a position command outputted from a numerical control device, the control parameter adjustment method being used for adjusting a corner clamp acceleration being a control parameter related to a corner deceleration processing function of the numerical control device, the control parameter adjustment method characterized in that
the control parameter adjustment method comprises the steps of:
performing first processing to notify the numerical control device of an adjustment NC program and register the adjustment NC program in the numerical control device;
performing second processing to cause the numerical control device to execute the adjustment NC program to output an adjustment position command;
performing third processing to find a largest error being a largest value in a difference between the adjustment position command and the position of the movable body fed back from a position detector of the movable body, the position of the movable body being fed back when the servo control device performs feedback control on the moving mechanism in such a way that the position of the movable body follows the adjustment position command;
performing fourth processing to judge whether or not the largest error is equal to or smaller than an allowable error, change the corner clamp acceleration to a smaller value if the largest error is judged as greater than the allowable error, and output the changed corner clamp acceleration to the numerical control device; and
iterating the second processing, the third processing, and the fourth processing until the largest error is judged as equal to or smaller than the allowable error in the fourth processing.

3. The control parameter adjustment method according to claim 1, characterized in that the acceleration/deceleration time constant changed to the larger value in the fourth processing and a set allowable value are compared with each other, and if the changed acceleration/deceleration time constant is judged as equal to or greater than the set allowable value, information indicating abnormal degradation of the moving mechanism is outputted to abnormality alarming means.

4. The control parameter adjustment method according to claim 2, characterized in that in the fourth processing, the corner clamp acceleration changed to the smaller value and a set allowable value are compared with each other, and if the changed corner clamp acceleration is judged as equal to or smaller than the set allowable value, information indicating abnormal degradation of the moving mechanism is outputted to abnormality alarming means.

5. A control parameter adjustment device used in a control system in which a servo control device performs feedback control on a moving mechanism in such a way that a position of a movable body moved by the moving mechanism follows a position command outputted from a numerical control device, the control parameter adjustment device being used for adjusting an acceleration/deceleration time constant being a control parameter related to a pre-interpolation acceleration/deceleration processing function of the numerical control device, the control parameter adjustment device characterized in that
the control parameter adjustment device comprises:
an adjustment NC program storage unit configured to store an adjustment NC program;
an NC program notification processing unit configured to read the adjustment NC program from the adjustment NC program storage unit and notify the numerical control device of the adjustment NC program;
an accuracy analysis processing unit configured to find a largest error being a largest value in a difference between an adjustment position command and the position of the movable body and judge whether or not the largest error is equal to or smaller than an allowable error, the adjustment position command being outputted from the numerical control device by executing the adjustment NC program, the position of the movable body being fed back from a position detector of the movable body when the servo control device performs feedback control on the moving mechanism in such a way that the position of the movable body follows the adjustment position command;
a parameter adjustment processing unit configured to change the acceleration/deceleration time constant to a larger value if the accuracy analysis processing unit judges that the largest error is greater than the allowable error; and
a parameter setting output processing unit configured to output the acceleration/deceleration time constant changed by the parameter adjustment processing unit to the numerical control device.

6. A control parameter adjustment device used in a control system in which a servo control device performs feedback control on a moving mechanism in such a way that a position of a movable body moved by the moving mechanism follows a position command outputted from a numerical control device, the control parameter adjustment device being used for adjusting a corner clamp acceleration being a control parameter related to a corner deceleration processing function of the numerical control device, the control parameter adjustment device characterized in that
the control parameter adjustment device comprises:
an adjustment NC program storage unit configured to store an adjustment NC program;
an NC program notification processing unit configured to read the adjustment NC program from the adjustment NC program storage unit and notify the numerical control device of the adjustment NC program;
an accuracy analysis processing unit configured to find a largest error being a largest value in a difference between an adjustment position command and the position of the movable body and judge whether or not the largest error is equal to or smaller than an allowable error, the adjustment position command being outputted from the numerical control device by executing the adjustment NC program, the position of the movable body being fed back from a position detector of the movable body when the servo control device performs feedback control on the moving mechanism in such a way that the position of the movable body follows the adjustment position command;
a parameter adjustment processing unit configured to change the corner clamp acceleration to a smaller value if the accuracy analysis processing unit judges that the largest error is greater than the allowable error; and
a parameter setting output processing unit configured to output the corner clamp acceleration changed by the parameter adjustment processing unit to the numerical control device.

7. The control parameter adjustment device according to claim 5, characterized in that the parameter setting output processing unit compares the acceleration/deceleration time constant changed to the larger value by the parameter adjustment processing unit and a set allowable value, and if judging the changed acceleration/deceleration time constant as equal to or greater than the set allowable value, outputs information indicating abnormal degradation of the moving mechanism to abnormality alarming means.

8. The control parameter adjustment device according to claim 6, characterized in that the parameter setting output processing unit compares the corner clamp acceleration changed to the smaller value by the parameter adjustment processing unit and a set allowable value, and if judging the changed corner clamp acceleration as equal to or smaller than the set allowable value, outputs information indicating abnormal degradation of the moving mechanism to abnormality alarming means.
